(19) United States
(12) Patent Application Publication
(10) Pub. No.: US 2026/0251144 A1
(43) Pub. Date: Aug. 27, 2026

(54) OPERATION CONTROL METHOD FOR ENGINE DRIVEN COMPRESSOR AND ENGINE DRIVEN COMPRESSOR

(71) Applicant: AIRMAN CORPORATION, Niigata (JP)

(72) Inventor: Yuki SATO, Niigata (JP)

(21) Appl. No.: 19/535,805

(22) Filed: Feb. 10, 2026

(30) Foreign Application Priority Data
Feb. 27, 2025 (JP) 2025-030714

(51) Int. Cl. F04C 28/06; F04C 18/16; F04C 28/10; F04C 28/26; F04C 29/02

(52) U.S. Cl. CPC F04C 28/06; F04C 18/16; F04C 28/10; F04C 28/26; F04C 29/021

(57) ABSTRACT

To reduce start-up load on an engine driven compressor to a minimum. An auxiliary opening/closing valve for opening and closing an intake flow passage that is in fluid communication with an intake port of a compressor body is provided, and an engine of the engine driven compressor is started while disabling control of an intake control valve by a pressure control valve and closing the auxiliary opening/closing valve. This enables the engine to start with load reduced as much as possible, even when starting the engine with the intake control valve opened, since the intake flow passage of the compressor body is closed by the auxiliary opening/closing valve, thereby restricting intake of the compressor body.

### TECHNICAL FIELD

The present invention relates to an operation control method for an engine driven compressor and an engine driven compressor that performs the operation control method, and more specifically, to an operation control method for an engine driven compressor that enables a start-up with load reduced and an engine driven compressor that performs the operation control method.

### BACKGROUND ART

An engine driven compressor including an engine such as a diesel engine as a drive source for driving a compressor body is widely used for outdoor work and the like such as at civil engineering construction sites and building construction sites where a power source is not readily available.

As such an engine driven compressor, Patent Document 1 described later describes an engine driven compressor 300 including a compressor body 340 of an oil-cooled type that compresses a gas to be compressed together with a lubricating oil and discharges a resulting gas-liquid mixed fluid as shown in FIG. 8.

The engine driven compressor 300 is provided with the compressor body 340 and the engine, which is not shown in the figure, described above as well as a receiver tank 360 for separating the lubricating oil discharged together with a compressed gas from the compressor body 340 and is configured such that the compressed gas after being separated from the lubricating oil in the receiver tank 360 can be supplied to a consumption side connected to a pneumatic tool or the like, which is not shown in the figure.

It is also configured such that the lubricating oil collected into the receiver tank 360 can be supplied to the compressor body 340 via an oil supply flow passage 361 including an oil cooler 362 and an oil filter, which is not shown in the figure, using a pressure inside the receiver tank 360.

Such an engine driven compressor 300 is provided with an intake control device 310 for controlling an intake amount of the compressor body 340 in response to the pressure inside the receiver tank 360 to ensure that the compressed gas with a stable pressure is supplied to the consumption side.

As the intake control device 310, the engine driven compressor 300 shown in FIG. 8 is provided with an intake control valve 311 of a normally open type that opens and closes an intake port 341 of the compressor body 340, and a control flow passage 312 that is in fluid communication with a valve closing pressure receiving chamber of the intake control valve 311, with the control flow passage 312 being in fluid communication with the receiver tank 360 via a block manifold 326 and a common flow passage 327.

The control flow passage 312 is provided with a pressure control valve 313 that opens when the pressure inside the receiver tank 360 is equal to or higher than a predetermined rated pressure.

Providing the intake control device 310 configured in such a manner causes the pressure control valve 313 to start introducing the compressed gas inside the receiver tank 360 into the valve closing pressure receiving chamber of the intake control valve 311 by starting opening operation when the pressure inside the receiver tank 360 reaches or exceeds the rated pressure, thereby causing the intake control valve 311 to throttle or close the intake port 341 of the compressor body 340 to reduce a generation amount of the compressed gas or stop its generation.

In contrast, when the pressure inside the receiver tank 360 drops below the rated pressure, the pressure control valve 313 closes to stop introducing the compressed gas into the valve closing pressure receiving chamber of the intake control valve 311. This causes the intake control valve 311 to open and the intake port 341 of the compressor body 340 to open, thereby starting the generation of the compressed gas by the compressor body 340.

In this way, it is configured such that repeatedly performing such intake control makes the pressure inside the receiver tank 360 close to the rated pressure described above.

In the engine driven compressor 300 configured as described above, the engine serving as the drive source for the compressor body 340 has low torque at low rotational speeds and is easily stalled when subjected to load during the start-up.

In particular, an engine driven compressor including a small engine with increased maximum output through adoption of a common rail system or addition of a supercharger to respond to demand for engine downsizing to comply with exhaust gas regulations offers benefits by means of electronic control, while a starting torque of the engine is smaller compared to a conventional engine that generates the maximum output of the same level, leading to a higher likelihood of stalling during the start-up.

Meanwhile, since the pressure inside the receiver tank 360 of the engine driven compressor 300 during the start-up is reduced to below the rated pressure (for example, atmospheric pressure) due to purging or the like performed during a shutdown, when starting the engine driven compressor 300 including the intake control device 310 described above, the intake control valve 311 is to be opened during the start-up of the engine, resulting in higher load on the engine from its start-up.

To address the problem of high load during the start-up of the engine, the engine driven compressor described in Patent Document 1 above is provided with a start-up load reduction device 320 to reduce the load during the start-up.

The engine driven compressor 300 shown in FIG. 8 is provided with a bypass flow passage 320 for establishing fluid communication between the valve closing pressure receiving chamber of the intake control valve 311 and the receiver tank 360 (or the block manifold 326 in the configuration shown in the figure) while bypassing the pressure control valve 313, and bypass valves 323 and 324 for opening and closing the bypass flow passage 320 as such a start-up load reduction device 320.

For the engine driven compressor 300 shown in FIG. 8, providing such a start-up load reduction device 320 establishes fluid communication between the valve closing pressure receiving chamber of the intake control valve 311 and the receiver tank 360 via the bypass flow passage 320 (321 and 322) by opening the bypass valves 323 and 324 to bypass the pressure control valve 313, and then the engine is started in this state.

This allows the load on the engine to be reduced immediately after the start-up is started by closing the intake control valve 311 to shift to no-load operation when the discharge of the compressed gas is started by rotation of a screw rotor of the compressor body 340.

Note that in a case in which the engine is started with the intake control valve 311 fully closed to reduce the start-up load, and then warm-up operation is performed while maintaining the intake control valve 311 closed, the pressure inside the receiver tank 360 during the warm-up operation is higher than the atmospheric pressure but remains relatively low, for example, approximately 0.1 MPa in gauge pressure.

However, since the lubricating oil collected into the receiver tank 360 is supplied to the compressor body 340 using the pressure inside the receiver tank 360, an amount of oil supplied to the compressor body 340 may be insufficient during the warm-up operation when the pressure inside the receiver tank 360 is low or immediately after shifting from the warm-up operation to normal operation.

Therefore, to secure an appropriate amount of oil supply to the compressor body 340 even during the warm-up operation or immediately after shifting from the warm-up operation to the normal operation, the engine driven compressor 300 described in Patent Document 1 shown in FIG. 8 is provided with a plurality of bypass flow passages 321 and 322 as the start-up load reduction device 320 described above, and the bypass valves 323 and 324 for opening and closing each of the bypass flow passages 321 and 322.

While the intake control valve 311 is fully closed upon the start-up of the engine by simultaneously opening all (two in the example shown in the figure) bypass valves 323 and 324 during the start-up of the engine, once an operation state of the engine stabilizes, for example, when predetermined conditions are satisfied (for example, predetermined operation time has elapsed) after the engine starts, insufficient oil supply during the warm-up operation or immediately after shifting to the normal operation can be prevented by closing one of the bypass valves 323 and 324 to reduce an amount of the compressed gas introduced into the valve closing pressure receiving chamber of the intake control valve 311 to open the intake control valve 311 at an opening less than a full opening, thereby raising the pressure inside the receiver tank 60 to an oil supply start pressure that is a predetermined pressure lower than the rated pressure but sufficient to secure the amount of oil supplied to the compressor body 340 before shifting to the normal operation.

### PRIOR ART DOCUMENTS

### Patent Documents

[Patent Document 1] Japanese Patent Publication No. 2022-185735.
[Patent Document 2] Japanese Patent Publication No. 2014-20267.

### SUMMARY OF INVENTION

### Problems to be Solved by Invention

The engine driven compressor 300 described in Patent Document 1 above is superior in that it can simultaneously satisfy conflicting requirements of starting the engine with the load reduced and securing the amount of oil supplied to the compressor body 340 during the warm-up operation or immediately after shifting from the warm-up operation to the normal operation.

However, in a case in which the engine driven compressor 300, which performs closing operation of the intake control valve 311 using the pressure inside the receiver tank 360 as operating pressure, is provided with the start-up load reduction device 320 with the configuration described above, the start-up of the engine is performed with the intake control valve 311 opened, and the intake control valve 311 closes after start-up operation of the engine is started.

Specifically, the intake control valve 311 closes only after the start-up of the engine causes the screw rotor of the compressor body 340 to rotate, the compressor body 340 starts the discharge of the compressed gas into the receiver tank 360, and the pressure inside the receiver tank 360 rises to or above the operating pressure of the intake control valve 311.

As a result, even the engine driven compressor 300 including the start-up load reduction device 320 described in Patent Document 1 is still subject to significant load on the engine during the start-up operation (for example, engine rotation with a starter motor and fuel ignition) and immediately thereafter, due to the intake control valve 311 not yet being closed.

Therefore, reducing such load on the engine as well during the start-up enables the start-up of the engine of the engine driven compressor 300 to be performed more smoothly.

According to the present invention, an auxiliary opening/closing valve starts opening before shifting to the normal operation, while in Patent Document 2, the auxiliary opening/closing valve remains “closed” until shifting to the normal operation. The method according to Patent Document 2 results in a state where a sufficient amount of oil supply to the compressor body 340 cannot be secured during the warm-up operation or immediately after shifting from the warm-up operation to the normal operation.

The present invention relates to a further improvement of the engine driven compressors described in Patent Documents 1 and 2 above and aims to provide an operation control method for an engine driven compressor that can further reduce the load on the engine during the start-up while maintaining functions of the engine driven compressor introduced in Patent Document 1 above, which enables both reduced start-up load and secured oil supply pressure, and an engine driven compressor that performs the operation control method.

### EFFECTS OF INVENTION

The configuration according to the present invention described above enables the engine driven compressor 1 that performs the operation control method according to the present invention to further reduce load on the engine during start-up while maintaining functions of the engine driven compressor 300 introduced in Patent Document 1 above, which enable both reduced start-up load and secured oil supply pressure.

Specifically, for the engine driven compressors 1 and 300 that close the intake control valves 11 and 311 using the pressure inside the receiver tanks 60 and 360 as the operating pressure, even in a case in which the engine is started with direct fluid communication between the receiver tanks 60 and 360 and the valve closing pressure receiving chambers of the intake control valves 11 and 311 established while bypassing the pressure control valves 13 and 313, the start-up operation of the engine itself is performed with the intake control valves 11 and 311 fully opened, and then the intake control valves 11 and 311 close.

However, the engine driven compressor 1 according to the present invention is provided with the auxiliary opening/closing valve 30 in addition to the intake control valve 11, enabling the engine to be started with the intake into the compressor body 40 controlled, in other words, with the load on the engine reduced as much as possible, even in a case in which the engine is started with the intake control valve 11 fully opened by starting the engine with the auxiliary opening/closing valve 30 closed, thereby enabling further reduction of the load during the start-up of the engine.

In this way, further reduction of the start-up load enables vibrations generated during the start-up to be suppressed, thereby reducing the load on connecting members such as rubber couplings that connect the engine and the compressor body 40 to extend their service life.

While the configuration of the start-up control device 20 described above for controlling opening and closing operation of the intake control valve 11 while disabling the control of the intake control valve 11 by the pressure control valve 13 is not particularly limited, the configuration employing the bypass flow passage 20 that enables fluid communication between the receiver tank 60 and the valve closing pressure receiving chamber 113 of the intake control valve 11 while bypassing the pressure control valve 13 as the start-up control device described above enables the control of the intake control valve 11 by the pressure control valve 13 to be disabled and opening and closing control of the intake control valve 11 during the start-up to be performed with a relatively simple configuration.

The configuration of the auxiliary opening/closing valve 30 to close when the pressure inside the receiver tank 60 is below a predetermined start-up load reduction pressure P1, which is a pressure lower than the rated pressure, start the opening operation at a pressure equal to or higher than the start-up load reduction pressure P1, and be fully opened when it exceeds the predetermined oil supply amount securing pressure P2, which is a pressure lower than the rated pressure, higher than the start-up load reduction pressure P1, and required for supplying oil to the compressor body 40, enables the opening and closing operation of the auxiliary opening/closing valve 30 to be performed by a pressure change inside the receiver tank 60 due to the opening/closing of the start-up control device (bypass flow passage) 20 and the change in flow passage area.

The configuration with the auxiliary opening/closing valve 30 described above as the opening/closing valve of a normally closed type that opens using the pressure inside the receiver tank 60 as the operating pressure eliminates the need for the controller 50 to control the operation of the auxiliary opening/closing valve 30, allowing the configuration of the controller 50 to be simplified.

In contrast, the configuration with the auxiliary opening/closing valve 30 provided with the electric motor 32′ for causing the valve body 31 of the auxiliary opening/closing valve 30 to perform the opening and closing operation enables the controller 50 to control the electric motor 32′ to control the opening and closing operation of the auxiliary opening/closing valve 30, allowing the structure of the auxiliary opening/closing valve 30 to be simplified.

The configuration in which the electric motor 32′ controls opening and closing of the auxiliary opening/closing valve 30 eliminates the need to raise the pressure inside the receiver tank 60 to obtain the operating pressure for the auxiliary opening/closing valve 30, eliminating the need to provide a small communication passage 39 that establishes fluid communication between the primary and secondary sides of the auxiliary opening/closing valve 30 when the auxiliary opening/closing valve 30 is closed, which also reduces the load generated due to compression of a gas to be compressed that is being drawn into the compressor body 40 via the small communication passage 39, achieving a further reduction in the start-up load.

Furthermore, an intake amount of the compressor body 40 can be controlled by controlling the opening of the auxiliary opening/closing valve 30, which may eliminate the need for the configuration for controlling a flow rate provided on the bypass flow passage 20 side to control the opening of the intake control valve 11 (for example, the second branch flow passage 22 and the second solenoid valve 24).

The configuration forming at least a portion of the bypass flow passage 20 by the set of the plurality of branch flow passages (the first branch flow passage 21 and the second branch flow passage 22) arranged in parallel, and provided with the solenoid on/off valves (the first solenoid valve 23 and the second solenoid valve 24) for opening and closing each of the branch flow passages 21 and 22 enables the flow passage area of the bypass flow passage 20 to be easily changed by changing the number of the solenoid on/off valves 23 and 24 that open or close.

In contrast, the configuration provided with a flow rate control valve 25 of the electrically operated type in the bypass flow passage, which changes the flow passage area of the bypass flow passage 20 by changing the opening of the flow rate control valve 25, enables the flow passage area to be changed steplessly, allowing the opening of the intake control valve 11 to be controlled more finely.

### BRIEF DESCRIPTION OF DRAWINGS

FIG. 1 is an explanatory diagram of an overall configuration of an engine driven compressor according to the present invention.

FIG. 2 is a cross-sectional view of a main part of an intake control valve including an auxiliary opening/closing valve, in which (A) illustrates one with the intake control valve not having a function as a check valve, and (B) illustrates one with the intake control valve having a function as a check valve.

FIG. 3 is an explanatory diagram of functions of a controller.

FIG. 4 is a time chart illustrating operation of each part of the engine driven compressor according to the present invention and changes in pressure inside a receiver tank.

FIG. 5 is a graph illustrating a pressure change inside the receiver tank during start-up of the engine driven compressor according to the present invention and a conventional engine driven compressor (Patent Document 1).

FIG. 6 is an explanatory diagram of the overall configuration of a modification of the engine driven compressor according to the present invention.

FIG. 7 is an explanatory diagram of the overall configuration of another modification of the engine driven compressor according to the present invention.

FIG. 8 is an explanatory diagram of the overall configuration of the conventional engine driven compressor (Patent Document 1).

### DESCRIPTION OF EMBODIMENTS

Next, embodiments of the present invention are described with reference to the accompanying drawings.

### Overall Configuration of an Engine Driven Compressor

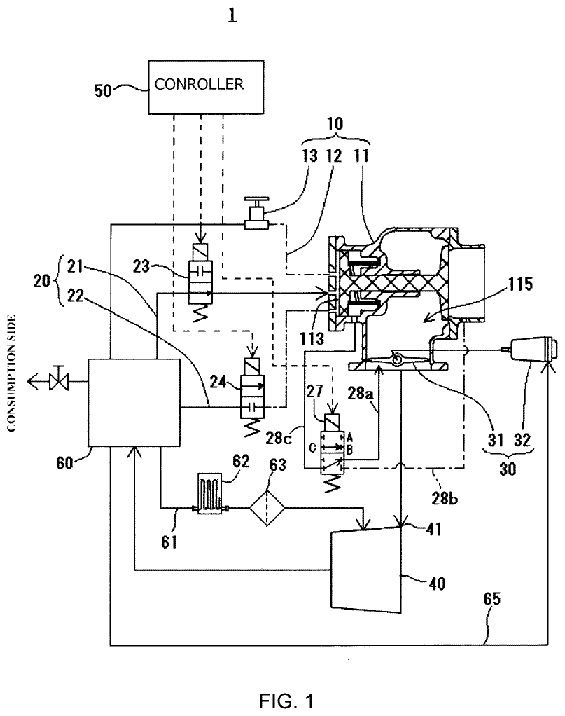

Reference numeral 1 in FIG. 1 denotes the engine driven compressor according to the present invention, and the engine driven compressor 1 includes: a compressor body 40, which is a screw compressor of an oil-cooled type, for compressing a gas to be compressed together with a lubricating oil; an engine, which is not shown in the figure, for driving the compressor body 40; and a receiver tank 60 for storing a compressed gas discharged from the compressor body 40, in which after the compressed gas discharged from the compressor body 40 together with the lubricating oil is processed to be separated from the lubricating oil in the receiver tank 60, the compressed gas with the lubricating oil removed can be supplied to a pneumatic tool or the like, which is not shown in the figure, connected to a consumption side.

It is configured such that the lubricating oil collected into the receiver tank 60 can be supplied back to the compressor body 40 via an oil supply flow passage 61 including an oil cooler 62 and an oil filter 63 by being pushed out by a pressure inside the receiver tank 60.

### Intake Control Device

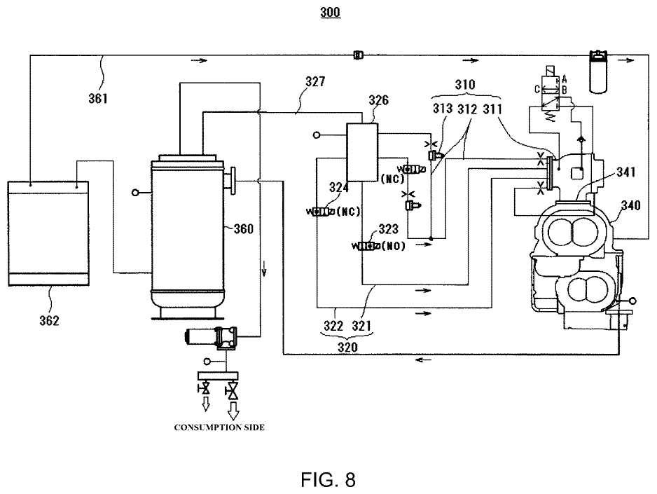

The configuration of the engine driven compressor 1 described above has the same configuration as the conventional engine driven compressor 300 described with reference to FIG. 8 in that it includes an intake control device 10 that controls intake by throttling or closing an intake port 41 of the compressor body 40 when the pressure inside the receiver tank 60 reaches or exceeds a predetermined rated pressure and fully opening it when the pressure drops below the rated pressure so as to make the pressure inside the receiver tank 60 close to the predetermined rated pressure.

The configuration is also the same as the conventional engine driven compressor 300 described with reference to FIG. 8 in that the intake control device 10 is configured with an intake control valve 11 that controls opening and closing of the intake port 41 of the compressor body 40, a control flow passage 12 that stablishes fluid communication between a valve closing pressure receiving chamber 113 of the intake control valve 11 and the receiver tank 60, and a pressure control valve 13 that opens the control flow passage 12 when the pressure inside the receiver tank 60 is equal to or higher than the predetermined rated pressure and closes the control flow passage 12 when the pressure is below the rated pressure, in response to the pressure inside the receiver tank 60.

### Intake Control Valve

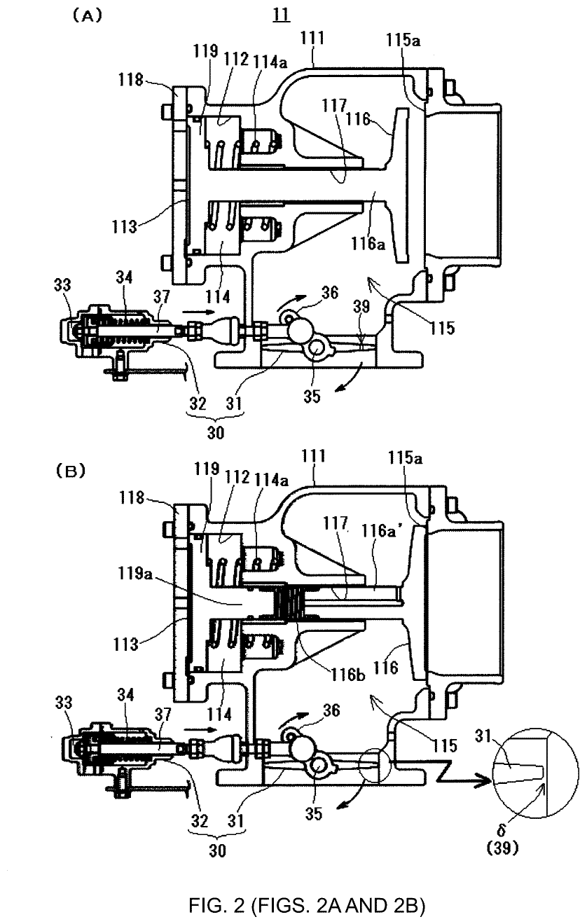

The intake control valve 11, which is a major component of the intake control device 10, opens and closes the intake port 41 of the compressor body 40, and in the present embodiment, the intake control valve 11 shown in FIG. 2 is used as an example.

The intake control valve 11 shown in FIG. 2 is configured such that an intake flow passage 115, through which the gas to be compressed passes, is formed by a space formed inside a body (a valve housing) 111, and the intake flow passage 115 can be blocked by seating a valve body 116 on a valve seat 115a provided inside the intake flow passage 115.

The valve body 116 is a so-called “umbrella-type valve,” in which a valve stem 116a is mounted to the valve body 116 having a disc-like shape, and is configured such that, with the valve stem 116a inserted into a sleeve 117 having a cylindrical shape formed inside the body 111, the valve body 116 can move between a closed-valve position where the valve body 116 is seated on the valve seat 115a and an open-valve position where the valve body 116 is spaced apart from the valve seat 115a by reciprocating the valve body 116 in an axial direction of the sleeve 117.

To enable such movement of the valve body 116, a cylinder 112 that is in fluid communication with the intake flow passage 115 via the sleeve 117 described above is formed coaxially with the sleeve 117 in the valve housing 111 of the intake control valve 11.

The cylinder 112 forms an airtight chamber by sealing an end portion on the opposite side of the side where the sleeve 117 is formed with an end plate 118 while the valve stem 116a is inserted into the sleeve 117, and a space inside the airtight chamber (cylinder) 112 is divided into two chambers via a pressure receiving body 119 connected to the other end of the valve stem 116a, or a piston in the present embodiment, to form the valve closing pressure receiving chamber 113 of the intake control valve 11 on the end plate 118 side and an auxiliary pressure receiving chamber 114 on the opposite side of the valve closing pressure receiving chamber 113 via the piston 119.

In the configuration shown in the figure, although a spring 114a for pressing the piston 119 toward the valve closing pressure receiving chamber 113 side is housed inside the auxiliary pressure receiving chamber 114 described above to enable the intake control valve 11 to be a normally open (NO) type, thereby enabling the auxiliary pressure receiving chamber 114 to function as a spring chamber, the spring 114a is not necessarily required to be provided in the auxiliary pressure receiving chamber 114 as long as the intake control valve 11 is enabled to be the normally open type.

Note that, instead of the intake control valve 11 shown in FIG. 2(A), an intake control valve 11 with a structure including a backflow prevention function as shown in FIG. 2(B) may be adopted.

In this configuration, the valve stem 116a is divided into the valve stem 116a′ provided on the valve body 116 side and the valve stem 119a provided on the pressure receiving body (piston) 119 side, and the spring 116b for biasing the valve body 116 toward the valve seat 115a is provided between the valve stem 116a′ on the valve body 116 side and the valve stem 119a on the pressure receiving body (piston) 119 side.

The valve body 116 is configured to be in contact with the valve seat 115a even in a case in which the pressure receiving body (piston) 119 is at the open-valve position on the left side of the figure due to a biasing force of the spring 116b.

Since the biasing force of the spring 116b is weak, the compressor body 40 is configured to be able to draw in the gas to be compressed by the valve body 116 being spaced apart from the valve seat 115a upon the pressure inside the intake flow passage 115 on a secondary side relative to the valve seat 115a becoming negative when the pressure receiving body (piston) 119 is at the open-valve position on the left side of the figure.

Conversely, even when the pressure receiving body (piston) 119 is at the open-valve position on the left side of the figure, backflow is prevented by the valve body 116 being pressed onto the valve seat 115a as the pressure inside the intake flow passage 115 on the secondary side relative to the valve seat 115a rises.

In this way, when adopting the intake control valve 11 with the backflow prevention function for the engine driven compressor 1 according to the present invention, even when the valve body 116 is in contact with the valve seat 115a, a state in which the compressor body 40 can perform intake by the valve body 116 being spaced apart from the valve seat 115a when the pressure inside the intake flow passage on the secondary side of the valve seat 115a drops below the pressure inside the intake flow passage on the primary side of the valve seat 115a is included in a state of “open” or “open-valve” of the intake control valve 11.

Although the intake control valve 11 described with reference to FIGS. 2(A) and 2(B) shows a configuration in which not only the valve body 116 and the valve seat 115a but also the cylinder 112, the piston 119, and the like for reciprocating the valve body 116 are all provided commonly inside the body (the valve housing) 111, a configuration in which an intake control valve body that does not include a drive mechanism for the valve body and a drive mechanism such as an unloader regulator that drives the valve body of the intake control valve body are each provided as separate bodies may be adopted, in which case the valve closing pressure receiving chamber 113, the auxiliary pressure receiving chamber 114 and the pressure receiving body 119 described above are formed inside the unloader regulator.

Although for the intake control valve 11 described with reference to FIGS. 2(A) and 2(B), the configuration in which the space inside the cylinder 112, which is an airtight chamber, is partitioned by providing the piston 119, which moves in response to the pressure of the compressed gas introduced into the valve closing pressure receiving chamber 113, as the pressure receiving body is adopted as the driving mechanism for the valve body 116, the pressure receiving body 119 is not limited to the piston described above, and anything capable of controlling the operation of the valve body 116 by the compressed gas introduced into the valve closing pressure receiving chamber 113, for example a diaphragm, may be used as the pressure receiving body 119.

### Start-Up Control Device (Bypass Flow Passage)

The engine driven compressor 1 according to the present invention is provided with a start-up control device 20 that controls the operation of the intake control valve 11 during the start-up while disabling opening and closing control of the intake control valve 11 by the pressure control valve 13 provided in the control flow passage 12 described above.

In the present embodiment, the bypass flow passage 20 that establishes fluid communication between the receiver tank 60 and the valve closing pressure receiving chamber 113 of the intake control valve 11 while bypassing the pressure control valve 13 described above is provided as such a start-up control device 20.

The bypass flow passage 20 is configured to be capable of opening and closing and to be capable of changing its flow passage area, thereby enabling the intake control valve 11 to be opened and closed and its opening to be controlled by starting or stopping the introduction of the compressed gas into the valve closing pressure receiving chamber 113 of the intake control valve 11 and by changing a flow rate.

To enable the bypass flow passage 20 to be capable of opening and closing and to be capable of changing the flow passage area, in the embodiment shown in the figure, the bypass flow passage 20 described above is configured with a combination of two branch flow passages (a first branch flow passage 21 and a second branch flow passage 22), and the first branch flow passage 21 and the second branch flow passage 22 are each provided with a solenoid on/off valve (a first solenoid valve 23 and a second solenoid valve 24) to make the flow passage area of the bypass flow passage 20 maximum by opening both the first and second solenoid valves 23 and 24, restrict the flow passage area by closing either one of the first and second solenoid valves 23 and 24, and block the bypass flow passage 20 by closing both the first and second solenoid valves 23 and 24.

Note that while the embodiment shown in the figure describes a configuration in which the bypass flow passage 20 described above is formed by two branch flow passages 21 and 22 and solenoid valves 23 and 24 provided in each of the branch flow passages 21 and 22, although not shown in the figure, the configuration may be such that the flow passage area of the bypass flow passage 20 can be changed in multiple steps by providing three or more branch flow passages and a solenoid valve to open and close each of the branch flow passages.

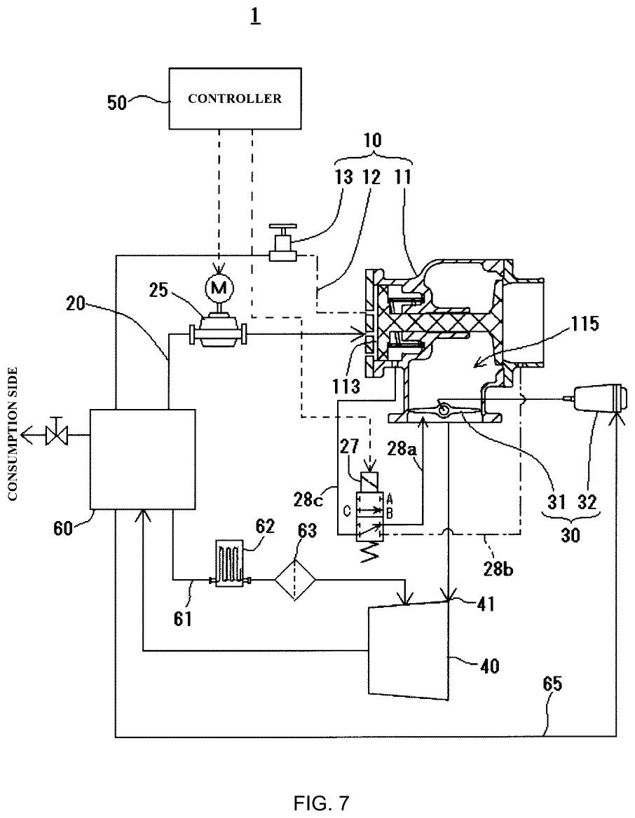

The configuration may be such that the opening and closing as well as the flow passage area of the bypass flow passage 20 can be steplessly controlled by providing a flow rate control valve 25 of an electrically operated type whose opening can be controlled by a motor or the like in a single bypass flow passage 20, as shown in FIG. 7, with the configuration of the bypass flow passage not being limited to the configuration shown in the figures.

Although in the embodiment shown in FIG. 1, the first solenoid valve 23 provided in the first branch flow passage 21 described above is a solenoid valve of the normally open (NO) type, and the second solenoid valve 24 provided in the second branch flow passage 22 described above is a solenoid valve of a normally closed (NC) type, the configuration is not limited to this, and various combinations may be adopted.

Note that in FIGS. 1, 6, and 7, reference numeral 27 denotes a three-way solenoid valve, and port C of the three-way solenoid valve 27 is in fluid communication with the auxiliary pressure receiving chamber 114 (the spring chamber, see FIG. 2) of the intake control valve 11 via a flow passage 28c, a flow passage 28a connected to port A is in fluid communication with the secondary side of an auxiliary opening/closing valve 30 described later, and a flow passage 28b connected to port B is in fluid communication with the primary side of the intake control valve 11.

This allows the auxiliary pressure receiving chamber 114 of the intake control valve 11 to be in fluid communication selectively with either the intake flow passage 115 on the secondary side of the auxiliary opening/closing valve 30 or the primary side of the intake control valve 11 by switching the three-way solenoid valve 27 (see FIGS. 1 and 2).

Note that the auxiliary pressure receiving chamber 114 of the intake control valve 11 may be capable of being vented to the atmosphere via a silencer, and the three-way solenoid valve 27 described above is not necessarily required to be provided.

### Auxiliary Opening/Closing Valve

The engine driven compressor 1 according to the present invention further includes the auxiliary opening/closing valve 30 for controlling the opening and closing of the intake flow passage 115 of the compressor body 40.

Although the auxiliary opening/closing valve 30 may be provided separately from the intake control valve 11 described above, in the present embodiment, the auxiliary opening/closing valve 30 is configured to be capable of opening and closing the intake flow passage 115 on the secondary side of the intake control valve 11 by being formed integrally inside the body (the valve housing) commonly with the intake control valve 11 described above.

In the embodiment shown in FIGS. 1 and 2, the auxiliary opening/closing valve 30 is formed as a combination of a butterfly valve 31 serving as the valve body and a regulator 32 of a bellows type that opens and closes the butterfly valve 31, the butterfly valve 31 is normally biased in a closing direction by the biasing force of a return spring 34 provided in the regulator 32, and a valve opening pressure receiving chamber 33 of the regulator 32, which is the valve opening pressure receiving chamber of the auxiliary opening/closing valve 30, is in fluid communication with the receiver tank 60 via an auxiliary control introduction circuit 65.

This causes the auxiliary opening/closing valve 30 to close and block the intake flow passage 115 when the pressure inside the receiver tank 60 introduced into the valve opening pressure receiving chamber 33 of the auxiliary opening/closing valve 30 is below a start-up load reduction pressure P1, which is a predetermined pressure lower than the rated pressure, to start opening operation and increase its opening as the pressure inside the receiver tank 60 rises when the pressure reaches or exceeds the start-up load reduction pressure P1, and to fully open when the pressure exceeds a predetermined oil supply amount securing pressure P2, which is a pressure lower than the rated pressure but higher than the start-up load reduction pressure P1 and is required to supply the lubricating oil to the compressor body 40.

Note that although the auxiliary opening/closing valve 30 is provided on the secondary side of the intake control valve 11 in the embodiment shown in the figures, the auxiliary opening/closing valve 30 may be provided on the primary side of the intake control valve 11.

In the configuration example shown in FIGS. 2(A) and 2(B), a pivot shaft 35 of the butterfly valve 31 is rotatably supported in a shaft hole, which is not shown in the figures, provided on the body 111 described above, a lever 36 is mounted on the pivot shaft 35, and a rod 37 provided on the regulator 32 is further connected to the lever 36, thereby enabling the butterfly valve 31 to be opened and closed in response to reciprocating movement of the rod 37 of the regulator 32.

In the embodiment shown in the figures, the regulator 32 of the bellows type is used, causing a bellows having a cup-like shape to move the piston to the right side of the figure against the biasing force of the return spring 34 while being inverted as the pressure inside the valve opening pressure receiving chamber 33 formed inside the body of the regulator 32 rises, thereby increasing a protruding length of the rod 37 connected to the piston.

In the embodiment shown in FIGS. 1 and 2, small fluid communication between spaces on the primary side and the secondary side of the butterfly valve 31 is configured to be established via a small communication passage 39 when the butterfly valve 31 is closed.

Such a small communication passage 39 may be provided by forming a through hole in the butterfly valve 31 as shown in FIG. 2(A) or, as shown in FIG. 2(B), by forming a small gap 8, which serves as the small communication passage 39 described above, between an outer periphery of the butterfly valve 31 and an inner wall of the body 111 when the butterfly valve 31 is fully closed, and various configurations may be adopted without being limited to the configurations shown in the figures.

The amount of gas drawn into the compressor body 40 via the small communication passage 39 described above with the butterfly valve 31 closed, in other words, the flow passage area of the small communication passage 39 may be any size sufficient to obtain an intake amount required for the pressure inside the receiver tank 60 to reach the start-up load reduction pressure P1 described above, at which the regulator 32 provided on the auxiliary opening/closing valve 30 starts operating, by means of the intake of the gas to be compressed via the small communication passage 39.

The valve opening pressure receiving chamber 33 of the regulator 32 of the auxiliary opening/closing valve 30 configured as described above is in fluid communication with the receiver tank 60 via the auxiliary control introduction circuit 65 as shown in FIG. 1, when the pressure inside the receiver tank 60 rises to or above the start-up load reduction pressure P1, at which the regulator 32 starts operating, the butterfly valve 31 starts opening the intake flow passage 115 in response to an introduction pressure, and when it rises to or above the predetermined oil supply amount securing pressure P2, the regulator 32 fully opens the butterfly valve 31, terminating intake control by the auxiliary opening/closing valve 30.

### Switches, Sensors, and the Like

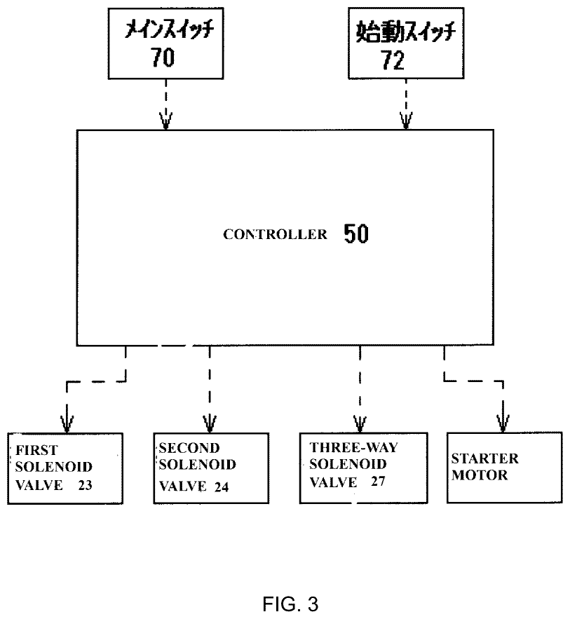

The engine driven compressor 1 according to the present invention configured as described above is provided with a controller 50, which is a control device for controlling the operation of each part of the engine driven compressor 1, and is also provided with switches for outputting electrical signals to the controller 50 (see FIG. 3).

The switches for performing operations, such as turning a main power supply of the engine driven compressor 1 ON or OFF, and starting or stopping the engine, may be provided as the switches described above.

For example, in the embodiment shown in FIG. 3, a main switch 70 and a start-up switch 72 are provided on an operation panel or the like of the engine driven compressor 1 as such switches.

The main switch 70 among these is used to switch the main power supply of the engine driven compressor 1 between “ON” and “OFF,” in which “OFF” indicates a stopped state with power supply to each part of the engine driven compressor 1 stopped, and “ON” indicates a so-called “accessory position” with the power to the engine, electronic control devices such as the controller 50, various sensors, instruments, and the like supplied.

The start-up switch 72 is a switch for starting the engine and, in the present embodiment, is configured as a switch of a push-button type such that the engine is started by supplying power to a starter motor of the engine when it is pressed and held for a predetermined time (for example, one second) or longer.

The engine driven compressor 1 including such a main switch 70 and a start-up switch 72 is configured to enable the engine driven compressor 1 to start and continue operation by switching the main switch 70 from an “OFF” position to an “ON” position and then pressing and holding the start-up switch 72 to start the engine, and to stop by switching the main switch 70 from the “ON” position to the “OFF” position.

Note that the switch for starting and stopping the engine driven compressor 1 is not limited to the configuration described above with the main switch 70 and the start-up switch 72 provided separately, but various configurations can be adopted as long as it can turn an accessory (the main switch) ON and OFF and turn the starter motor ON and OFF, and the switch for turning the accessory ON and OFF and the starter motor ON and OFF may be configured using a known key switch or the like that allows the position to be switched from the OFF position to the ON position (the accessory position) and further to a start position where the starter motor of the engine is driven by inserting and turning a key.

### Controller

The engine driven compressor 1 according to the present invention configured as described above is provided with a controller 50, which is the electronic control device for controlling the operations of the starter motor of the engine, the first solenoid valve 23, the second solenoid valve 24 and the three-way solenoid valve 27 based on the operation of the switches described above or the like.

The controller 50 performs the following control operations based on operation states of the switches 70 and 72 described above, a count of a built-in timer, and detection signals from sensors provided as necessary and the like.

### (1) Start-Up Preparation

When an operator switches the main switch 70 from “OFF” to “ON,” power is supplied to each part of the engine driven compressor 1, causing the controller 50 to start up.

### (2) Start-Up Load Reduction Operation

After turning the main switch 70 ON as described above, when the operator presses and holds the start-up switch 72, the controller 50 energizes (ON) the second solenoid valve 24 to open it while maintaining the first solenoid valve 23 de-energized (OFF), in other words, in an open state.

In this way, the valve closing pressure receiving chamber 113 of the intake control valve 11 is in fluid communication with the receiver tank 60 via the bypass flow passage 20 (the first and second branch flow passages 21 and 22), thereby disabling the control of the intake control valve 11 by the pressure control valve 13 and enabling closing operation to be performed by introducing the compressed gas from the receiver tank 60 into the valve closing pressure receiving chamber 113 of the intake control valve 11 as operating pressure even in a case in which the pressure inside the receiver tank 60 is below the rated pressure and has not reached the operating pressure of the pressure control valve 13.

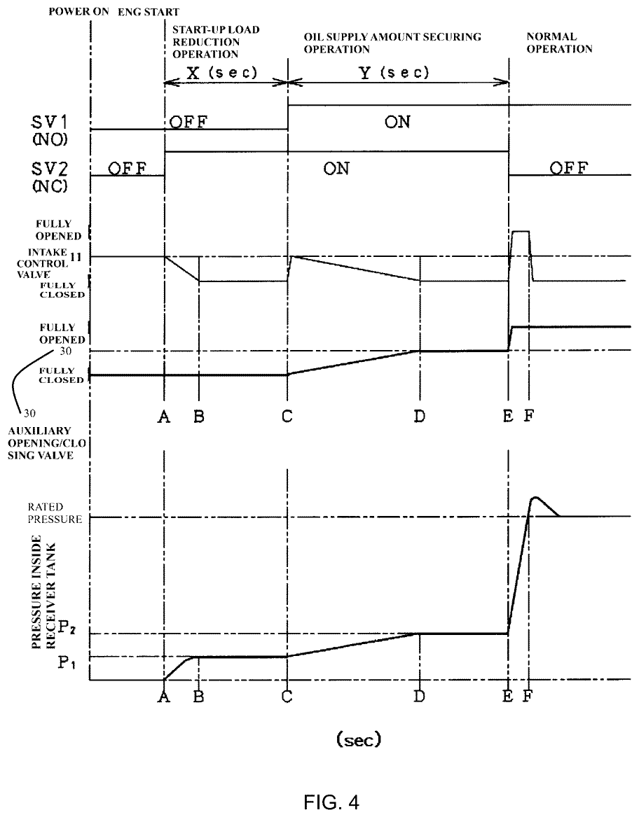

In this way, while the valve closing pressure receiving chamber 113 of the intake control valve 11 is in fluid communication with the receiver tank 60 via the bypass flow passage 20 by opening the first and second solenoid valves 23 and 24, and the valve opening pressure receiving chamber 33 of the auxiliary opening/closing valve 30 is in fluid communication with the receiver tank 60 via the auxiliary control introduction circuit 65, since the pressure inside the receiver tank 60 at this time is at atmospheric pressure or close to the atmospheric pressure, the intake control valve 11 and an auxiliary opening/closing valve 30 are in the open state and in a closed state, respectively (see time A in FIG. 4).

Note that the configuration with the three-way solenoid valve 27 provided as shown in FIG. 1 further allows the controller 50 to switch the three-way solenoid valve 27 to a position where the auxiliary pressure receiving chamber 114 of the intake control valve 11 is in fluid communication with the intake flow passage 115 on the secondary side of the auxiliary opening/closing valve (a position establishing fluid communication between ports C and A).

Then, the controller 50 starts the engine by driving the starter motor, thereby starting start-up load reduction operation (see A-C in FIG. 4).

While the pressure inside the receiver tank 60 is at atmospheric pressure or close to the atmospheric pressure with the intake control valve 11 in the open state during the start-up of the engine, the engine can be started with the load on the engine reduced as much as possible since the intake flow passage 115 of the compressor body 40 is closed by the auxiliary opening/closing valve 30 of the normally closed type.

When a screw rotor of the compressor body 40 connected to the engine starts rotating by starting the engine in this way, the compressor body 40 draws in air from the intake flow passage 115 via the small communication passage 39 provided in the auxiliary opening/closing valve 30 to generate the compressed gas, raising the pressure inside the receiver tank 60 by introducing the compressed gas generated in this way into the receiver tank 60.

When the pressure inside the receiver tank 60 rises to or above the operating pressure of the intake control valve 11, the intake control valve 11 closes to stop the intake via the small communication passage 39 provided in the auxiliary opening/closing valve 30, causing pressure rise inside the receiver tank 60 to stop (time B in FIG. 4).

Therefore, continuing such operation until, for example, the timer completes counting a predetermined time X (seconds) allows the start-up load reduction operation, in which the pressure inside the receiver tank 60 is maintained below the predetermined start-up load reduction pressure P1, to be performed.

Note that in the configuration provided with the three-way solenoid valve 27 as shown in FIG. 1, operation of the three-way solenoid valve 27 by the controller 50 causes the auxiliary pressure receiving chamber 114 of the intake control valve 11 to be in fluid communication with the intake flow passage 115 on the secondary side of the auxiliary opening/closing valve 30 during the start-up of the engine, allowing the closing operation of the intake control valve 11 to be performed smoothly by enabling smooth exhaust from the auxiliary pressure receiving chamber 114 due to negative pressure generated inside the intake flow passage 115 as the compressor body 40 starts intake.

### (3) Oil Supply Amount Securing Operation

The controller 50 starts energizing the first solenoid valve 23 to close the first solenoid valve 23 when the built-in timer completes counting the predetermined time, thereby starting the oil supply amount securing operation.

As shown in FIG. 1, in the configuration with the three-way solenoid valve 27, the controller 50 further operates the three-way solenoid valve 27 to cause the auxiliary pressure receiving chamber 114 of the intake control valve 11 to be in fluid communication with the primary side of the intake control valve 11, thereby venting it to the atmosphere.

Closing the first solenoid valve 23 reduces the flow passage area of the bypass flow passage 20 by the amount of blockage of the first branch flow passage 21, resulting in a decrease in the amount of compressed gas introduced to the valve closing pressure receiving chamber 113 of the intake control valve 11, which causes the fully closed intake control valve 11 to open to a predetermined opening corresponding to a reduced amount of the compressed gas introduced (time C in FIG. 4).

The opening of this intake control valve 11 starts the intake of the gas to be compressed via the small communication passage 39 of the auxiliary opening/closing valve 30, which allows the compressor body 40 to resume generating the compressed gas, thereby causing the pressure inside the receiver tank 60 to start rising (time C in FIG. 4).

This raises the pressure inside the receiver tank 60 above the start-up load reduction pressure P1, thereby causing the auxiliary opening/closing valve 30 to start opening and increasing the opening of the auxiliary opening/closing valve 30 in response to the pressure rise inside the receiver tank 60 (time C-D in FIG. 4).

Meanwhile, as the pressure inside the receiver tank 60 rises, the pressure of the compressed gas introduced into the valve closing pressure receiving chamber 113 of the intake control valve 11 via the second branch flow passage 22 also rises. Therefore, as the pressure inside the receiver tank 60 rises, the intake control valve 11 starts the closing operation again and closes when the pressure inside the receiver tank 60 reaches the predetermined oil supply amount securing pressure P2 (time C-D in FIG. 4).

The closing of the intake control valve 11 maintains the pressure inside the receiver tank 60 at the oil supply amount securing pressure P2 and allows the oil supply amount securing operation to continue until a predetermined time Y (seconds) has elapsed in this state.

### (4) Normal Operation

When the timer determines by counting that the predetermined time Y (seconds) has elapsed since the start of the oil supply amount securing operation, the controller 50 stops energizing the second solenoid valve 24 (OFF) to close the second solenoid valve 24, thereby blocking the second branch flow passage 22 to cut off fluid communication between the receiver tank 60 and the valve closing pressure receiving chamber 113 of the intake control valve 11 via all branch flow passages of the bypass flow passage 20.

This cancels the disabling of the control of the intake control valve 11 by the pressure control valve 13 in the control flow passage 12, causing the opening and closing control of the intake control valve 11 by the pressure control valve 13 to start.

Note that in the configuration including the three-way solenoid valve 27 shown in FIG. 1, the controller 50 maintains a switching position of the three-way solenoid valve 27 in a state during the oil supply amount securing operation, in other words, the three-way solenoid valve 27 maintains a state in which the auxiliary pressure receiving chamber 114 of the intake control valve 11 is in fluid communication with the primary side of the intake control valve 11 and vented to the atmosphere.

During the oil supply amount securing operation, the pressure inside the receiver tank 60 is maintained at the oil supply amount securing pressure P2, which is lower than the rated pressure, and since the pressure control valve 13 is in a state where the control flow passage 12 is closed, the intake control valve 11 fully opens when introduction of the operating pressure via the second branch flow passage 22 is stopped by the closing of the second solenoid valve 24 (time E in FIG. 4).

This allows the compressor body 40 to start intake of the gas to be compressed and generation of the compressed gas, causing the pressure inside the receiver tank 60 to start rising and exceed the oil supply amount securing pressure P2, which causes the auxiliary opening/closing valve 30 to fully open.

This terminates intake control of the compressor body 40 by the auxiliary opening/closing valve 30, resulting in a shift to the normal operation in which the intake control of the compressor body 40 is performed solely by the opening and closing control of the intake control valve 11 by the pressure control valve 13 provided in the control flow passage 12.

Then, the intake control valve 11 closes when the pressure inside the receiver tank 60 reaches or exceeds the rated pressure (time F in FIG. 4), causing the intake control to be performed so as to make the pressure inside the receiver tank 60 close to the rated pressure.

Accordingly, with the configuration of the present invention, the pressure inside the receiver tank 60 is raised to the predetermined oil supply amount securing pressure P2 by performing the oil supply amount securing operation described above before shifting to the normal operation, and in this state, even in a case in which the engine driven compressor 1 shifts to the normal operation at a state of full load by fully opening the intake control valve 11 and fully opening the auxiliary opening/closing valve 30, an abnormal rise in a discharge temperature due to shortage of the oil supply amount of the lubricating oil and the like can be suitably prevented.

### Comparison of Effects

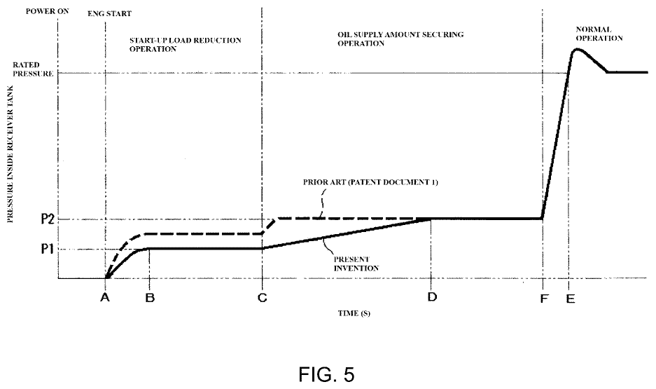

FIG. 5 illustrates a graph comparing states of pressure change inside the receiver tank between the engine driven compressor 1 according to the present invention that performs the operation control method described above and the engine driven compressor 300 of Patent Document 1 above.

As shown in FIG. 5, the pressure inside the receiver tank during the start-up is maintained at a lower level for the engine driven compressor 1 that performs the operation control method according to the present invention, compared to the engine driven compressor of Patent Document 1.

A lower pressure inside the receiver tank during the start-up means that a generation amount of the compressed gas during the start-up is lower, and consequently, the load on the engine during the start-up is lower, and it has been confirmed that further reduction in start-up load is achieved by performing the operation control method according to the present invention while retaining functions that the engine driven compressor described in Patent Document 1 has.

### [Example of Modification] Example of Modification to the Auxiliary Opening/Closing Valve

The engine driven compressor 1 according to the present invention described with reference to FIG. 1 above is described using an example in which the auxiliary opening/closing valve 30 is configured to perform opening and closing operation using the pressure inside the receiver tank 60 as the operating pressure.

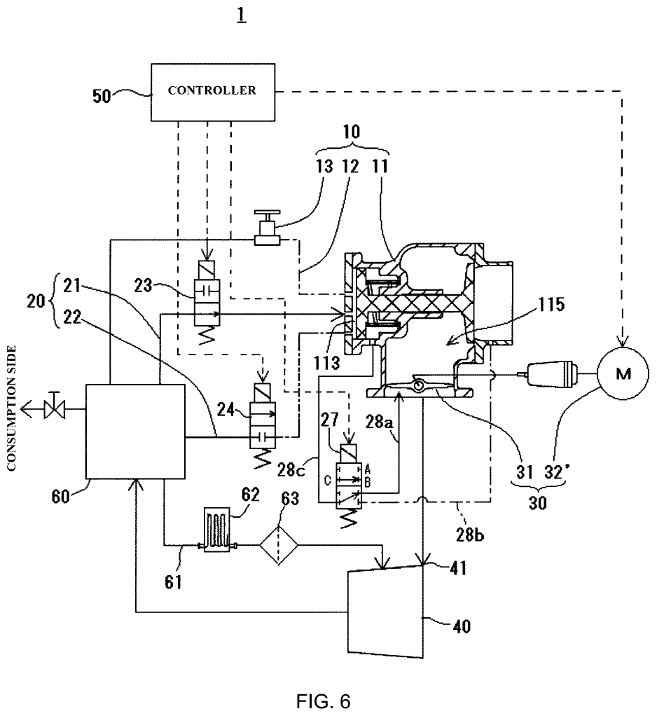

In contrast, the engine driven compressor 1 shown in FIG. 6 is configured such that an electric motor 32′ for operating the auxiliary opening/closing valve 30 is provided, and the controller 50 drives the electric motor 32′ to control the operation of the auxiliary opening/closing valve 30.

In this case, the controller 50 may be configured to control the opening and closing operation of the auxiliary opening/closing valve 30 at predetermined timings, or alternatively, a pressure sensor for detecting the pressure inside the receiver tank 60 may be provided such that the operation of the auxiliary opening/closing valve 30 is controlled in response to the pressure inside the receiver tank 60 detected by the pressure sensor.

In the embodiment described with reference to FIG. 1, since the pressure inside the receiver tank 60 is used as the operating pressure to open the auxiliary opening/closing valve 30, a configuration with the small communication passage 39 of the auxiliary opening/closing valve 30 provided to secure the operating pressure for the auxiliary opening/closing valve 30 is adopted.

In contrast, the present embodiment adopts a configuration in which the auxiliary opening/closing valve 30 performs the opening and closing operation using the electric motor 32′, eliminating the need to secure the operating pressure, which eliminates the need to provide the small communication passage 39, thereby enabling the engine to be started with the intake flow passage of the compressor body 40 completely blocked to further reduce the start-up load.

Furthermore, the intake amount of the compressor body 40 can be controlled by controlling the opening of the auxiliary opening/closing valve 30, eliminating the need for the configuration provided on the bypass flow passage 20 side to control the opening of the intake control valve 11 (for example, the second branch flow passage 22 and the second solenoid valve 24).

### REFERENCE SIGNS LIST

1 engine driven compressor
10 intake control device
11 intake control valve
111 body (valve housing)
112 cylinder
113 valve closing pressure receiving chamber
114 auxiliary pressure receiving chamber
114a spring
115 intake flow passage
115a valve seat
116 valve body
116a, 116a′ valve stem
116b spring
117 sleeve
118 end plate
119 pressure receiving body
119a valve stem
12 control flow passage
13 pressure control valve
20 start-up control device (bypass flow passage)
21 first branch flow passage
22 second branch flow passage
23 first solenoid valve (solenoid on/off valve)
24 second solenoid valve (solenoid on/off valve)
25 flow rate control valve
27 three-way solenoid valve
28a, 28b, 28c flow passage
30 auxiliary opening/closing valve
31 butterfly valve (valve body)
32 regulator
32′ electric motor
33 valve opening pressure receiving chamber
34 return spring
35 pivot shaft
36 lever
37 rod
39 small communication passage
40 compressor body
41 intake port
50 controller
60 receiver tank
61 oil supply flow passage
62 oil cooler
63 oil filter
65 auxiliary control introduction circuit
70 main switch
72 start-up switch
300 engine driven compressor
310 intake control device
311 intake control valve
312 control flow passage
313 pressure control valve
320 start-up load reduction device (bypass flow passage)
321, 322 bypass flow passage
323, 324 bypass valve
326 block manifold
327 common flow passage
340 compressor body
341 intake port
360 receiver tank
361 oil supply flow passage
362 oil cooler
P1 start-up load reduction pressure
P2 oil supply amount securing pressure

1. An operation control method for an engine driven compressor including: an engine; a compressor body of an oil-cooled type driven by the engine; a receiver tank that introduces a gas-liquid mixed fluid of a compressed gas and a lubricating oil discharged from the compressor body, separates the gas-liquid mixed fluid into the compressed gas and the lubricating oil, and supplies the separated lubricating oil to the compressor body using a pressure inside thereof; an intake control valve that controls intake into the compressor body; a control flow passage that establishes fluid communication between a valve closing pressure receiving chamber of the intake control valve and the receiver tank; and a pressure control valve that opens and closes the control flow passage in response to the pressure inside the receiver tank, the operation control method for the engine driven compressor, during normal operation, controlling opening and closing operation of the intake control valve to perform intake control of the compressor body by the pressure control valve opening the control flow passage when the pressure inside the receiver tank is equal to or higher than a predetermined rated pressure and closing the control flow passage when the pressure is below the rated pressure, the operation control method comprising:
providing an auxiliary opening/closing valve that opens and closes an intake flow passage that is in fluid communication with an intake port of the compressor body;
performing a start-up load reduction operation in which the engine is started while disabling control of the intake control valve by the pressure control valve and closing the auxiliary opening/closing valve, and the pressure inside the receiver tank is maintained below a predetermined start-up load reduction pressure that is a pressure lower than the rated pressure;
performing an oil supply amount securing operation in which when termination conditions for the start-up load reduction operation are satisfied, the intake control valve is set to an opening less than a full opening, and opening operation of the auxiliary opening/closing valve is started, the pressure inside the receiver tank is raised to a predetermined oil supply amount securing pressure that is lower than the rated pressure but higher than the start-up load reduction pressure and required to secure oil supplied to the compressor body, and maintained at the oil supply amount securing pressure; and
cancelling the disabling to start opening and closing control of the intake control valve by the pressure control valve, and fully opening the auxiliary opening/closing valve to shift to the normal operation when the termination conditions for the oil supply amount securing operation are satisfied.

2. The operation control method for an engine driven compressor according to claim 1, wherein
a bypass flow passage capable of changing its flow passage area that enables fluid communication between the receiver tank and the valve closing pressure receiving chamber of the intake control valve while bypassing the pressure control valve is provided,
wherein fluid communication between the receiver tank and the valve closing pressure receiving chamber of the intake control valve is established via the bypass flow passage with its flow passage area maximized before starting the engine, thereby performing the start-up load reduction operation with the intake control valve closed upon start-up of the engine,
wherein the flow passage area of the bypass flow passage is restricted, and the intake control valve is opened to an opening less than the full opening, thereby terminating the start-up load reduction operation and starting the oil supply amount securing operation, and
wherein fluid communication between the receiver tank and the valve closing pressure receiving chamber of the intake control valve via the bypass flow passage is blocked, thereby terminating the oil supply amount securing operation and shifting to the normal operation.

3. The operation control method for an engine driven compressor according to claim 1, wherein
the auxiliary opening/closing valve is fully closed when the pressure inside the receiver tank is below the start-up load reduction pressure, starts the opening operation when the pressure reaches or exceeds the start-up load reduction pressure, and is fully opened when the pressure exceeds the oil supply amount securing pressure.

4. The operation control method for an engine driven compressor according to claim 3, wherein
a small communication passage for establishing fluid communication between a primary side and a secondary side of the auxiliary opening/closing valve when the auxiliary opening/closing valve is closed is provided,
wherein opening and closing of the auxiliary opening/closing valve is performed using the pressure inside the receiver tank as operating pressure.

5. The operation control method for an engine driven compressor according to claim 1, wherein
the opening and closing of the auxiliary opening/closing valve is performed by an electric motor.

6. The operation control method for an engine driven compressor according to claim 2, wherein
at least a portion of the bypass flow passage is formed by a set of a plurality of branch flow passages arranged in parallel, with each of the branch flow passages capable of being opened and blocked to change the flow passage area of the bypass flow passage is performed by changing the number of branch flow passages that are opened or blocked.

7. The operation control method for an engine driven compressor according to claim 2, wherein
the change in the flow passage area of the bypass flow passage is performed by operating a flow rate control valve provided in the bypass flow passage.

8. An engine driven compressor comprising: an engine; a compressor body of an oil-cooled type driven by the engine; a receiver tank that introduces a gas-liquid mixed fluid of a compressed gas and a lubricating oil discharged from the compressor body, separating the gas-liquid mixed fluid into the compressed gas and the lubricating oil, and supplies the separated lubricating oil to the compressor body using a pressure inside thereof; an intake control valve that controls intake into the compressor body; a control flow passage that establishes fluid communication between a valve closing pressure receiving chamber of the intake control valve and the receiver tank; and a pressure control valve that opens and closes the control flow passage in response to the pressure inside the receiver tank, wherein, during normal operation, opening and closing operation of the intake control valve is controlled to perform intake control of the compressor body by the pressure control valve opening the control flow passage when the pressure inside the receiver tank is equal to or higher than a predetermined rated pressure and closing the control flow passage when the pressure is below the rated pressure, the engine driven compressor further comprises:
a start-up control device that controls opening and closing of the intake control valve while disabling the opening and closing control of the intake control valve by the pressure control valve;
an auxiliary opening/closing valve that opens and closes an intake flow passage that is in fluid communication with an intake port of the compressor body; and
a controller that controls operation of each part of the engine driven compressor,
wherein the auxiliary opening/closing valve is configured to close when the pressure inside the receiver tank is below a predetermined start-up load reduction pressure that is a pressure lower than the rated pressure, start opening operation at a pressure equal to or higher than the start-up load reduction pressure, and be fully opened when it exceeds a predetermined oil supply amount securing pressure, which is a pressure lower than the rated pressure, higher than the start-up load reduction pressure, and required for supplying oil to the compressor body, and
wherein the controller:
operates the start-up control device to start the engine while disabling control of the intake control valve by the pressure control valve and performs start-up load reduction operation, in which the pressure inside the receiver tank is maintained below a predetermined start-up load reduction pressure that is a pressure lower than the rated pressure;
performs, when termination conditions for the start-up load reduction operation are satisfied, an oil supply amount securing operation in which the pressure inside the receiver tank is raised to the oil supply amount securing pressure and maintained at such pressure by operating the start-up control device to set the intake control valve to an opening less than a full opening; and
cancels, when the termination conditions for the oil supply amount securing operation are satisfied, the disabling by the start-up control device, starts the control of the intake control valve by the pressure control valve, raises the pressure inside the receiver tank to or above the oil supply amount securing pressure, and shifts to the normal operation.

9. The engine driven compressor according to claim 8, wherein
a bypass flow passage capable of changing its flow passage area that enables fluid communication between the receiver tank and the valve closing pressure receiving chamber of the intake control valve while bypassing the pressure control valve is provided as the start-up control device, and
wherein the controller:
establishes fluid communication between the receiver tank and the valve closing pressure receiving chamber of the intake control valve via the bypass flow passage with its flow passage area maximized before starting the engine, thereby performing the start-up load reduction operation with the intake control valve closed upon start-up of the engine;
restricts the flow passage area of the bypass flow passage to open the intake control valve to an opening less than the full opening, thereby shifting from the start-up load reduction operation to the oil supply amount securing operation; and
blocks fluid communication between the receiver tank and the valve closing pressure receiving chamber of the intake control valve via the bypass flow passage, thereby shifting from the oil supply amount securing operation to the normal operation.

10. The engine driven compressor according to claim 8, wherein
the auxiliary opening/closing valve is configured to be an opening/closing valve of a normally closed type that opens using the pressure inside the receiver tank as operating pressure, and
wherein a small communication passage for establishing fluid communication between a primary side and a secondary side of the auxiliary opening/closing valve when the auxiliary opening/closing valve is closed is provided.

11. The engine driven compressor according to claim 8, wherein
an electric motor for performing the opening and closing operation of a valve body of the auxiliary opening/closing valve is provided on the auxiliary opening/closing valve,
wherein the controller controls the opening and closing of the auxiliary opening/closing valve by controlling the operation of the electric motor.

12. The engine driven compressor according to claim 9, wherein
at least a portion of the bypass flow passage is formed by a set of a plurality of branch flow passages arranged in parallel, and a solenoid on/off valve that opens and closes each of the branch flow passages is provided, and
wherein the controller performs changing the flow passage area of the bypass flow passage by changing the number of the solenoid on/off valves that open or close.

13. The engine driven compressor according to claim 9, wherein
a flow rate control valve of an electrically operated type is provided in the bypass flow passage, and
wherein the controller performs changing the flow passage area of the bypass flow passage by changing the opening of the flow rate control valve.
